(19) United States
(12) Patent Application Publication
(10) Pub. No.: US 2003/0061604 A1
(43) Pub. Date: Mar. 27, 2003

(54) Software-code configurable digital appliance

(75) Inventors: Albert F. Elcock, Havertown, PA (US); John Kamieniecki, Lafayette Hill, PA (US); Christopher J. Stone, Newtown, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 09/960,557

(22) Filed: Sep. 21, 2001

(51) Int. Cl. G06F 9/44; G06F 15/177

(52) U.S. Cl. 717/170; 709/220

(57) ABSTRACT

A software-code configurable digital appliance, such as a television settop box, is provided for operating in a network, such as a subscription television system. A storage component of the appliance stores different versions of at least one of firmware and application program code. A processing component is provided for selecting an appropriate version of the firmware and/or application program code, depending on predetermined criteria relating to the network to which the appliance is connected. The selected version is loaded into an operating component of the appliance to enable the appliance to operate in the network. The different versions of firmware and/or application program code are adapted to enable the appliance to be deployed in any of a plurality of incompatible networks.

### BACKGROUND OF THE INVENTION

The present invention relates to networked digital consumer appliances, such as television settop boxes, and more particularly to apparatus and methods for automatically configuring such appliances for operation within any one of multiple network environments.

The communication of digital cable services from program providers to end-users is accomplished through several steps. The first involves transmission of the digitally encoded services from broadcast service providers to cable service provider facilities. The second step involves manipulating video and audio data by the digital cable service provider using head-end equipment at their facility. The final step involves transmission of digital information to the end-user via a coaxial cable and decoding the transmission at the consumers' site. Head-end equipment at a cable operator facility provides received programs on specific channels that are broadcast to customers over copper cable and/or fiber optic cable, typically via hybrid fiber-cable (HFC) distribution plants. A settop box located at the customer facility tunes and decodes incoming broadcasts. The settop boxes tune to a desired channel frequency and modulate the received signal onto an unused television channel (usually channel 3 or 4). An example of such a settop box is the Model DCT 2000 manufactured by the Broadband Communications Sector of Motorola, Inc., Horsham, Pa., U.S.A.

Firmware and application software provided within the settop box performs the functions of booting the settop system, displaying user-accessible software functions, and displaying menus for program guides. Consumer products, such as audio/video receivers and DVD players also contain software code for feature implementation. Settop cable television decoders may be designed to work with a number of different cable television protocols. Each environment (e.g., each different cable network) may require different operation and communication parameters, which may, in turn, require a software or firmware code change for proper functioning and for feature implementation. While current state-of-the-art settop interactive digital terminals, such as the DCT-2000, are delivered from the factory with firmware and application software code capable of tuning digital and analog signals received over a particular cable network, code changes to allow support of alternate network protocols require changing such code. In instances where the cable service provider supports the same protocols used by the factory, this process may be performed over the radio-frequency (RF) transmission medium and stored in electrically programmable non-volatile memory within the settop product. When the factory-installed protocol is not supported, any code upgrade might require shipment of the unit to a service facility for such a code change. For the case where software or firmware changes can be accomplished through the RF transmission medium, the RF-transmission protocols between the network and the settop device must match, allowing communication to be established between a controller at the head-end facility and the settop device. In instances where the settop is incapable of communicating with the head-end because of incompatibility between the communication protocols, it would be advantageous to enable the settop to be easily reconfigured to allow such communication. It would be further advantageous if such reconfiguration were provided automatically. Still further, it would be advantageous to provide a network appliance, such as a settop, that can be automatically configured upon boot-up to work in any network to which the appliance is presently connected. In this manner, a generic network appliance could be provided, that does not require connection to a specific network, such as a particular cable television system.

The present invention provides a software code configurable digital network appliance having the aforementioned and other advantages.

### SUMMARY OF THE INVENTION

The present invention provides a software-code configurable digital appliance designed for operating in any one of a variety of different network environments, such as different digital cable or satellite television networks. In accordance with the invention, the digital appliance includes a storage component for storing alternative versions of firmware and/or application program code. It also contains a processing component for selecting an appropriate version of firmware and/or application program code, depending upon predetermined criteria relating to the network in which the appliance is deployed. The selected version is loaded into an operating component of the digital appliance to enable the appliance to operate within the particular network.

The digital appliance may be a television settop box that interfaces with a subscription television system. Various versions of firmware and application software code are stored during manufacture of the appliance and are adapted to enable the settop to be deployed in any of a plurality of incompatible subscription television systems.

The digital appliance selects an appropriate version of firmware and/or software in response to input from the particular subscription television system to which the appliance is connected. At system initialization, rudimentary program code, supplied in non-volatile memory, permits initialization of the processing component. A configuration process is initiated that can optionally work in conjunction with information supplied through a user interface, to select the appropriate firmware and/or software version to load into the operating component of the appliance. Loading of the selected firmware and/or software results in proper operation of the appliance in conjunction with the network to which is it coupled.

In the event that the network to which the appliance is coupled is not supported by the available versions of firmware and/or software, the operating component can optionally be provided with rudimentary default code to provide at least a basic operation. Alternatively, one of the available versions can comprise code that, when loaded into the operating component, will enable the appliance to achieve at least a rudimentary communication with the network. Once such rudimentary communication is established, the network can provide new code to the appliance, enabling more sophisticated communication and/or further functionality.

Corresponding methods are also provided.

### BRIEF DESCRIPTION OF THE DRAWINGS

FIG. 1 is a block diagram of video transmission and reception equipment for a digital cable television system with an enhanced digital terminal at the end-user location;

FIG. 2 is a block diagram of the DCP, schematically depicting a firmware/application software switch in accordance with the invention; and

FIG. 3 is a flowchart indicating the operation of a firmware/application software selection algorithm in accordance with the invention.

### DETAILED DESCRIPTION OF THE INVENTION

A preferred embodiment of an apparatus and method for enabling digital consumer network appliances to operate within different network environments is described. The embodiment should not be construed as a constraint on the use of the disclosed invention, but rather as an example of one use thereof.

In a broadband cable or satellite television system, various services, including scheduled television programming, pay-per-view (PPV), video-on-demand (VOD), Internet access, and the like are provided to end-users. These services are transmitted from broadcast service providers to cable or satellite service provider facilities where head-end equipment at the cable or satellite service provider facility manipulates the received video and audio data and transmits these signals to the end-user via coaxial and/or fiber optic cable or via a satellite downlink. At the end-user location, the signals are received by, for example, an enhanced digital terminal (sometimes referred to as an enhanced settop box or a digital convergence platform (DCP)) that includes a settop decoder and other audio/video components in one system. An enhanced digital terminal supports multiple functions including tuning and decoding incoming broadcasts and playing selections from alternate digital video sources such as DVD. The enhanced terminal provides output signals at baseband and/or on an RF carrier having a frequency corresponding to an unused television channel (usually television channel 3 or 4).

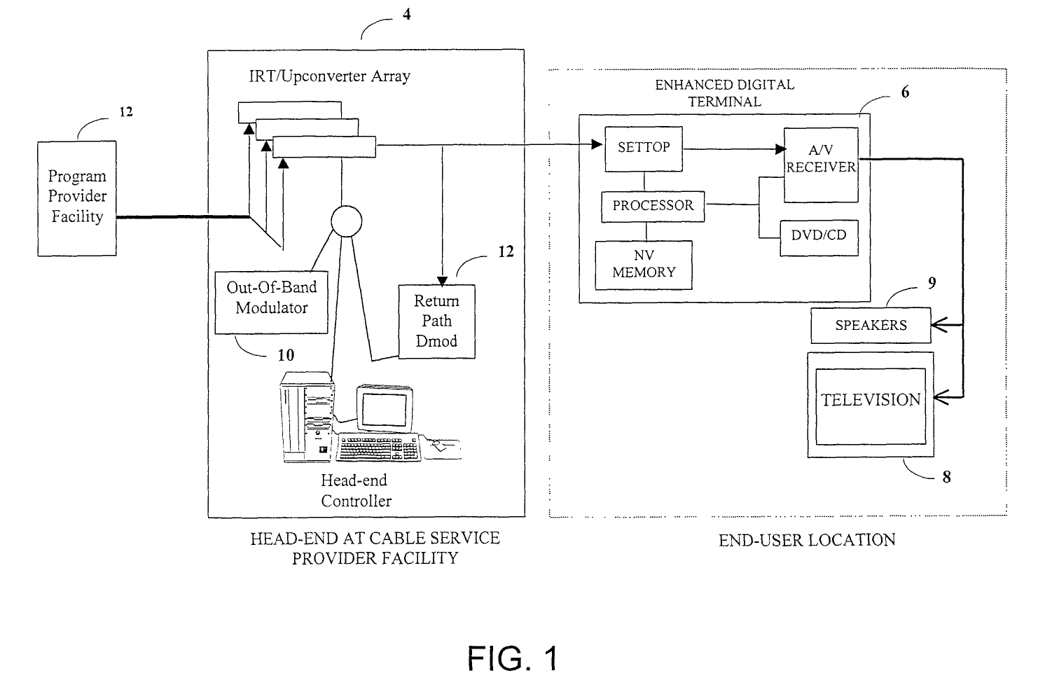

FIG. 1 shows the basic components of a cable television system. It should be appreciated that other communication network systems are well known in the art, and the invention can be adapted to function with such other systems as well. At a program provider facility 2, analog and digital video and audio signals supplied by broadcast service providers are sampled, quantized, and compressed into representative digital signals. After encryption, these signals are packetized and multiplexed onto intermediate frequency (IF) carrier frequencies and transmitted to a cable service provider facility. At this location, they are frequency shifted and data is subsequently decrypted, error-corrected, filtered and modulated onto an Electronics Industry Association (EIA) carrier frequency by head-end equipment 4. The digital signals are communicated to a population of user terminals 6 (e.g., enhanced digital terminals) at the end-user location. Such terminals typically include settop decoders, where television signals are decoded, decrypted and demodulated for viewing by the end-user (e.g., cable subscriber) on a television 8. Two components used in the head-end system by the cable service provider facilitate access to program information and end-user access control. A Digital Out-of-Band (OOB) modulator 10 (such as a Quadrature Phase Shift Keyed (QPSK) modulator) provides program and access control information to end-users. Such program information can comprise, for example, broadcast service guides (e.g., electronic program guides, often referred to as “EPGs”). Access control information includes encryption keys and authorization information for broadcast service access control. The supplied channel guide allows a user to reference desired broadcast programs and select the corresponding display channel.

A Return Path Demodulator (RPD) 12 functions to receive and demodulate, for example, PPV requests from settop decoders at end-user locations. In the present embodiment, the settop decoder is part of an enhanced digital terminal 6, although it can be provided as a separate component. The terminal combines a Motorola DCT-2000 like settop with a DVD/CD player and an A/V receiver/amplifier. The A/V receiver/amplifier provides baseband output to television 8 and speakers 9. Alternatively, an RF output could be provided to the television, as well known in the art. Other outputs from the terminal 6 can include, e.g., coaxial, component video, and S-video (YC). It is envisioned that future systems may comprise fiber optic cables instead of electrical baseband or RF implementations. Non-volatile (“NV”) memory is also provided in the terminal 6 to store firmware and/or software, as discussed in greater detail below.

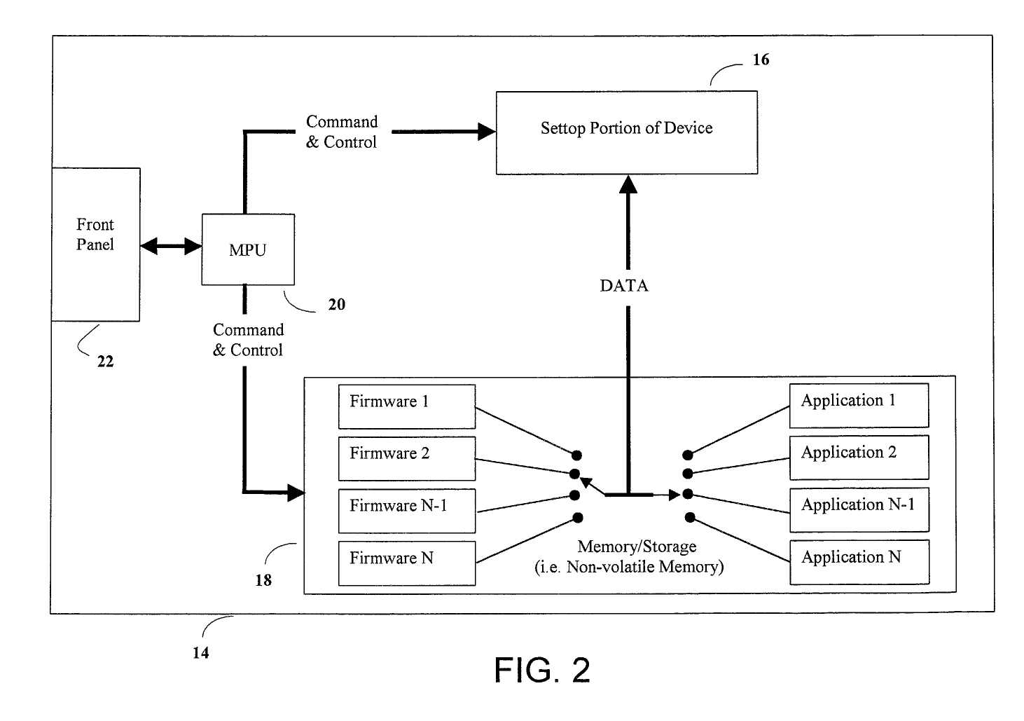

The selection of application software and firmware for an enhanced digital terminal, such as terminal 6, is the focus of the present invention. In accordance with the invention, a software and firmware selection portion 14 is provided for the terminal 6 as shown in FIG. 2. The components that make up such an apparatus include a settop component 16 similar in design to the DCT-2000 from Motorola, Inc., a microprocessor unit 20, a front panel assembly 22, and a non-volatile memory component 18. It should be appreciated that FIG. 2 represents an improved implementation of the enhanced digital terminal of FIG. 1, and that only the new features are illustrated in FIG. 2. The settop 16, memory 18, and processor 20 of FIG. 2 correspond to the settop, NV memory and processor of terminal 6 illustrated in FIG. 1. The other components of terminal 6 are not illustrated in FIG. 2.

Various versions of firmware and application software are loaded into nonvolatile memory 18 at the factory. These various versions of firmware and application software are designed to be applicable in a variety of different cable-network environments. The software and firmware selection portion of the enhanced digital terminal operates following an initial power-on self-boot by enabling a configuration process that may include user interaction. The function of the software and firmware selection portion 14 is to determine which version of the factory or warehouse installed firmware and/or application program code is required for a particular environment (i.e., a particular network), and to transfer that code to the settop portion of the device 16 from the non-volatile memory 18. The MPU 20 controls the flow of information and controls the selection of software code from the non-volatile memory component. The front panel 22 acts as the user-interface for displaying selected information to the user and allowing input by the user. Alternatively, the user interface can comprise an on-screen display (OSD) generated by the settop on the television display. The technology for providing OSD functionality is well known in the art, and is used, for example, to generate set-up menus for video components such as DVD players, VCRs and the like directly on a user's television screen.

If the user were to operate the terminal 6 in an alternate, non-compatible cable-network environment, the configuration process would be repeated and applicable firmware and application program code would be recalled from non-volatile memory and would replace the versions of firmware and software previously loaded into the settop portion 16. In this manner, a single terminal model can be used in a variety of different, incompatible television systems. Thus, if a user moves to a new location with a different cable system, the terminal can be easily configured for this system. Moreover, the same model terminal can be sold to different subscription television operators for distribution to end users, even when the television systems of the different operators use different communication protocols or when the television systems are otherwise incompatible.

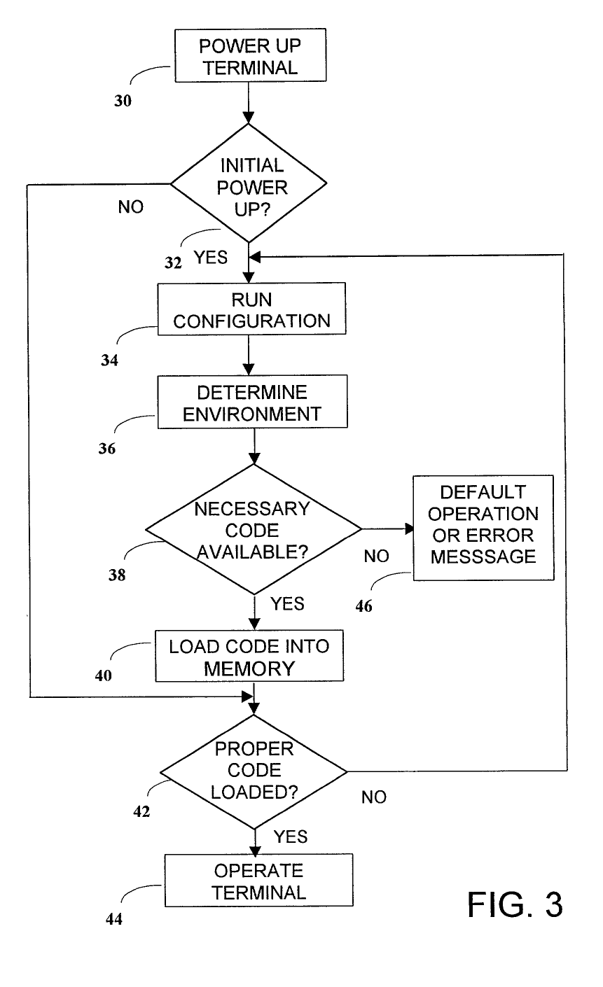

A flowchart describing the method of firmware and application code selection used by the terminal is shown in FIG. 3. The process steps can be implemented in software, hardware, or a combination thereof, as will appreciated by those skilled in the art. The end-result of the process is to transfer a software code object and/or data, pre-loaded into non-volatile memory of the terminal, to the settop portion of the device in order to perform a firmware and/or application installation or change. Moreover, software images can be pre-loaded into the non-volatile memory of the terminal and transferred to the settop portion to enable at least rudimentary communications to be made with different incompatible networks. Different software images can be provided for the different networks. Once such rudimentary communication is made when the terminal is connected to a particular network, the network operator can take advantage of the communication to download more comprehensive firmware and/or operating software to the terminal, enabling enhanced functionality and/or full communication ability within that particular network.

The process illustrated in FIG. 3 commences at box 30, when full power (as opposed to standby power) is applied to the enhanced digital terminal. At box 32, a determination is made as to whether this is the initial power up a consumer premises. Although the configuration process will normally only need to be run the first time a power-up occurs at a new consumer premises, it may also be run after a power interruption, e.g., after a power outage or when the terminal is unplugged from AC power. Alternatively, a flag can be set in non-volatile memory after the initial configuration, so that the configuration process does not have to be re-run after a power outage or other power interruption.

If the current power-up is the initial power up, configuration firmware that is pre-stored in the terminal at the factory or warehouse is run, as indicated at box 34. The configuration firmware determines the environment in which the terminal is currently running, as indicated at box 36. The environment is, e.g., the cable television system to which the terminal is currently connected. The environment is detected, for example, by reading a message contained in signals received from the network to which the terminal is coupled, by user interaction (e.g., generating an on-screen display requesting the user to enter a code identifying the cable provider), or by any other suitable means as will be apparent to those skilled in the art. Once the environment has been determined, a determination is made at box 38 as to whether the necessary firmware and/or application code for that environment has been pre-loaded into the terminal non-volatile memory 18 (FIG. 2). If so, this code is loaded into the operating portion of the terminal, e.g., into the settop box portion thereof, as indicated at box 40. A test can then be performed at box 42 to verify that the proper code has been successfully loaded. If not, the program loops back to box 34 so that the configuration process can be run again. Otherwise, the terminal is operated using the properly loaded code, as indicated at box 44.

Once the configuration has been completed by loading the appropriate code for the network to which the consumer appliance (e.g., enhanced digital terminal) is connected, future power-ups of the appliance will skip the configuration program. This is indicated at box 32, where power-ups subsequent to the initial power up cause the program to jump to box 42 and subsequently, box 44 for full operation of the appliance. In the event that the necessary firmware and/or application code for the consumer appliance was not pre-loaded into memory 18 for the particular environment to which the appliance is coupled, the configuration process will detect this at box 38. In this event, the appliance can be run in a basic mode using default operation firmware and/or application code pre-loaded into memory 18, or an error message will be provided to the consumer (e.g., via a display on the appliance or a television on-screen display), indicating that the appliance cannot be run on the present network. If a default operation is provided, it will typically only include rudimentary features. As an alternative, a software image can be pre-loaded into memory 18 for allowing the appliance to achieve at least rudimentary communication with the network. Once such communication is established, more functional code can be downloaded to the appliance from the network to provide greater compatibility and/or functionality.

It should be appreciated that the flowchart of FIG. 3 is only an example, and that other routines can be used to initialize a consumer appliance in accordance with the invention.

It should now be understood that the invention provides apparatus and methods for installing and/or upgrading firmware and/or application code within a digital consumer appliance, such as an enhanced digital terminal which includes television settop functionality, that does not require access to an external communications channel. It accomplishes this by storing a variety of versions of the necessary code within a non-volatile memory that can be accessed freely by the appliance. In this manner, the same appliance can be configured for use in any one of a variety of different environments, such as different subscription television networks, local area networks, wide area networks, wireless networks, and the like. Thus, an appliance from one manufacturer can be adapted for use in a network based on another manufacturer's hardware, software and/or protocols. The invention allows manufacturers to ship a product with multiple code objects installed at the factory or warehouse, which objects are specific to various installations and/or configurations, and which allow the device to load the code objects specific to the installation/configuration in which it is placed. The invention is particularly useful, for example, in connection with consumer electronic products such as settop boxes, audio/visual receivers, televisions and the like. As the inventive apparatus and methods do not require software to be downloaded from, e.g., a particular RF network, products can be provided which are upgradeable and/or configurable regardless of the network with which they are used. Should the environment change (e.g., the consumer moves to a new location), the configuration process will determine if the currently running firmware/software is applicable to the new environment. If not, then the device will determine which version of the firmware/application is required, load the applicable code, and operate accordingly.

Although the invention has been described in connection with a specific embodiment thereof, it should be appreciated that various modifications and adaptations can be made without departing from the scope, as set forth in the claims.

What is claimed is:

1. A software-code configurable digital appliance for operating in a network, comprising:
a storage component for storing different versions of at least one of firmware and application program code; and
a processing component for:
(a) selecting an appropriate version of said at least one of firmware and application program code depending on predetermined criteria relating to said network, and
(b) loading the selected version into an operating component of said appliance to enable the appliance to operate in said network.

2. A digital appliance in accordance with claim 1, further comprising rudimentary program code in non-volatile memory that permits initialization of said processing component.

3. A digital appliance in accordance with claim 1, further comprising a user interface operatively associated with said processing component for enabling a user to facilitate the selection of said appropriate version.

4. A digital appliance in accordance with claim 1, comprising a television settop box.

5. A digital appliance in accordance with claim 4 wherein said network comprises a subscription television system.

6. A digital appliance in accordance with claim 5 wherein said processing component selects said appropriate version in response to the particular subscription television system to which said appliance is connected.

7. A digital appliance in accordance with claim 6 wherein said different versions are stored in said storage component during manufacture of the appliance.

8. A digital appliance in accordance with claim 7 wherein said different versions are adapted to enable said settop to be deployed in any of a plurality of incompatible subscription television systems.

9. A digital appliance in accordance with claim 1, wherein at least one of said versions comprises code to enable at least rudimentary communication between said operating component and said network.

10. A method for configuring a digital appliance for operating in a network, comprising:
storing different versions of at least one of firmware and application program code in a memory of said digital appliance;
selecting an appropriate version of said at least one of firmware and application program code depending on predetermined criteria relating to said network, and
loading the selected version into an operating component of said appliance to enable the appliance to operate in said network.

11. A method for configuring a digital appliance in accordance with claim 10 wherein said different versions are stored in said memory during manufacture of the appliance.

12. A method for configuring a digital appliance in accordance with claim 10, further comprising activating rudimentary program code stored in non-volatile memory to initialize said digital appliance.

13. A method for configuring a digital appliance in accordance with claim 10, further comprising presentation of a user interface for enabling a user to facilitate the selection of said appropriate version.

14. A method for configuring a digital appliance in accordance with claim 10, wherein said appropriate version is selected in accordance with a particular subscription television system to which said appliance is connected.

15. A method for configuring a digital appliance in accordance with claim 14, wherein said different versions are adapted to enable said appliance to be deployed in any of a plurality of incompatible subscription television systems.

16. A method for configuring a digital appliance in accordance with claim 10, wherein said different versions are adapted to enable said appliance to be deployed in any of a plurality of incompatible networks.

17. A method for configuring a digital appliance in accordance with claim 16, wherein said appropriate version is selected in response to the particular network to which said appliance is connected.

18. A method for configuring a digital appliance in accordance with claim 10, wherein said operating component uses rudimentary default code if said network is not supported by the versions stored in said memory.

19. A method for configuring a digital appliance in accordance with claim 10, wherein said appropriate version comprises code to enable rudimentary communication between said operating component and said network.

30. A method for configuring a digital appliance in accordance with claim 19, comprising the further step of using said rudimentary communication to provide additional code to said operating component from said network, said additional code providing at least one of (i) more sophisticated communication and (ii) additional functionality for said appliance.
